(19) United States
(12) Patent Application Publication
(10) Pub. No.: US 2005/0021882 A1
(43) Pub. Date: Jan. 27, 2005

(54) External storage device for storing update history

(75) Inventors: Keisuke Murata, Odawara (JP); Akira Kojima, Sakawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Global Storage Technologies Japan, Ltd., Odawara-shi (JP)

(21) Appl. No.: 10/861,783

(22) Filed: Jun. 3, 2004

(30) Foreign Application Priority Data
Jun. 3, 2003 (JP) 2003-157750

(51) Int. Cl. G06F 11/34

(52) U.S. Cl. 710/19; 714/2

(57) ABSTRACT

Embodiments of the invention provide an external storage system having a plurality of magnetic disk units which include a history storing device that automatically stores update information about the magnetic disk units as a history, and that can perform data recovery with a high degree of accuracy whenever a failure occurs. In one embodiment, an external storage system comprises a plurality of magnetic disk units being connected to one another according to a fiber channel protocol. At least one of the plurality of magnetic disk units is a history storing device that monitors each frame being transmitted to the plurality of magnetic disk units, and has an update history storing mode in which update history information is automatically obtained and stored in a storage medium of the history storing device.

### CROSS-REFERENCES TO RELATED APPLICATIONS

This application relates to and claims priority from Japanese Patent Application No. 2003-157750, filed on Jun. 3, 2003.

### BACKGROUND OF THE INVENTION

This invention relates generally to magnetic disk units and, more particularly, to an external storage system of magnetic disk units including an external storage device configured to store update history information about the magnetic disk units.

As a result of the study by the inventors of this invention, as far as an external storage system having one or more magnetic disk units is concerned, because the capacity of a magnetic disk unit (HDD (Hard Disk Drive) device) is increasing in recent years, a loss of data caused by a failure of even one HDD device is so large that it cannot be overlooked. Therefore, the data recovery technology required when a failure occurs is becoming more important than before.

For example, the technology intended to achieve data recovery by redundancy, such as a RAID (Redundant Arrays of Inexpensive Disks) system, is not tolerant to failures occurring simultaneously in a plurality of disks. Thus, when considering the amount of lost data, a better data recovery method is required.

In addition, as another technology intended for data recovery, there is, for example, a method in which a backup is periodically created. This method is disclosed in Japanese Patent Application Laid-Open No. Hei 5-210466. This patent document discloses the following technology: in order to take a backup, a loop by use of an optical fiber cable is provided, wherein the loop is separated from usual I/O with a host computer; and a backup is then created according to a request from the host computer.

However, if the technology which periodically creates a backup as described above is used, when a failure occurs, data gets back to a state of the last created backup. Therefore, this cannot be said to be a complete data recovery method. What is more, because it takes a long time to create a backup of a large-capacity HDD device, the backup cannot be performed frequently. Accordingly, a data recovery method which can be operated in a reasonable period of time as well as with a high degree of accuracy is desired.

Additionally, also in the case of the Japanese Patent Application Laid-Open No. Hei 5-210466, trying to always keep a backup required for completely restoring data makes it necessary to issue a backup creation request every time an update request is issued to a HDD device. Thus, it is not realistic to issue a backup request every time an update is made. A backup, therefore, is created after a lapse of some time. This results in a loss of data from a point of time at which the last backup is created to a point of time at which a failure occurs.

Incidentally, backup methods as the technology for data recovery as described above can be broadly classified into two categories. One is a method in which all data are periodically backed-up. This method requires the enormous capacity of backup storage medium because the capacity of a HDD device becomes larger. Moreover, time required for creating a backup is too long to complete it frequently, which inevitably reduces the accuracy in data recovery. The other method is first to create a backup of all data at a certain point of time, and then to store only a difference from that point of time as an additional backup. Generally speaking, updates of data to the HDD device seldom cover the whole HDD medium, but rather tend to be concentrated on a part of the HDD medium. Accordingly, it is possible to reduce the required capacity of the storage medium to a large extent, and also to shorten the backup time to a large extent, as compared with taking a backup of the whole HDD device. On the other hand, as compared with the former method that keeps a replication of the data itself, the second method takes a longer time to complete data recovery.

Accordingly, if the increasing capacity of a HDD device is taken into consideration, the latter method is realistic. However, even if the latter method is used, backups must be taken at regular intervals, and data updated after the last backup is lost, which presents a problem.

### BRIEF SUMMARY OF THE INVENTION

Embodiments of the present invention solve the problems of prior approaches, and provide an external storage device or history storing device that stores, as a history, update information about one or more magnetic disk units such as a HDD device, and that can perform data recovery with a high degree of accuracy whenever a failure occurs. In specific embodiments, the technology is applied to an external storage system having a plurality of magnetic disk units being connected to one another by use of the FCAL (Fibre Channel Arbitrated Loop) interface according to the fiber channel protocol (FCP: Fibre Channel Protocol). The history storing device is used to store update history related to the plurality of magnetic disk units.

In order to achieve data recovery when a failure occurs in particular, update histories of a plurality of HDD devices are automatically obtained and stored without the intervention of a host computer. In the FCAL protocol, the host computer and all of the HDD devices are circularly connected to one another by use of a fiber cable, forming a system called a loop. There is a single direction of data transmission in the loop. Data transmitted from the host computer to the HDD devices, and data transmitted from the HDD devices to the host computer, are transmitted through the HDD devices one by one on the loop by a bucket brigade method.

A unit of data transmission at this time is called a frame. An ID of a destination HDD device is stored in this frame. A HDD device checks the ID, and if it is judged that this HDD device is a destination, then this destination HDD device receives the frame. After that, the destination HDD device holds the frame, and does not relay the frame to the downstream HDD devices so as to complete the data transmission. In this manner, because the data transmission is performed by the bucket brigade method, a frame transmitted from the host computer always passes through all of the HDD devices. The present embodiment makes good use of this feature to store update histories in at least one HDD device on the loop.

For example, an update history storing HDD device is placed at a downstream point directly connected to the host computer. This HDD device is specifically used for storing histories, and therefore does not accept a usual write command. This HDD device monitors all frames transmitted from the host computer, and stores all write commands and all written data in its own HDD medium. In this case, the history storing HDD device continuously stores write commands and written data even if there is no trigger, and consequently does not stop a data flow, which does not cause degradation in performance during the operation of the system.

Further, preparing for an emergency, the history storing HDD device takes a copy and stores it into a low-speed, high-capacity medium such as a tape at fixed intervals, for instance, once every day. In order to realize such operation, a plurality of history storing HDD devices having the same functions are used. As a result, even if one of them is stopped, the remaining history storing HDD devices can continuously obtain update histories while allowing the system to operate.

In the event of a failure occurring, data is first restored from a backup that has been obtained by a general method. However, data written immediately before the occurrence of the failure is not restored without additional processing. Here, writing requests issued by the host computer before the occurrence of the failure are reissued by use of the history information according to the present approach. Because all information required for writing is kept in the history information, it is possible to completely and accurately replicate the writing performed before the occurrence of the failure.

More specifically, the following method is used in actual operation: creating a rough backup at fixed intervals by use of the general backup method; preparing for a failure occurring after the last backup, creating update histories by use of the method according to an embodiment of the present invention; and if a failure actually occurs, using this history information to perform correct data recovery. Thus, if the history information is kept in the update history storing HDD device, whenever an accident such as a drive failure occurs, it is possible to restore data to a state immediately before the occurrence of the accident. Accordingly, data can be restored more accurately than the conventional method.

### BRIEF DESCRIPTION OF THE DRAWINGS

FIG. 1 is a block diagram illustrating an example of an external storage system that includes an history storing device for storing update history according to one embodiment of the present invention.

FIG. 2 is an explanatory diagram illustrating a format example of update history information according to one embodiment of the present invention.

FIG. 3 is an explanatory diagram illustrating an example of a frame header format according to the FCAL protocol according to one embodiment of the present invention.

FIG. 4 is a flowchart illustrating an example of a flow for usual operation of the system according to one embodiment of the present invention.

FIG. 5 is a flowchart illustrating an example of a flow used when a history storing HDD device obtains update history information according to one embodiment of the present invention.

FIG. 6 is an explanatory diagram illustrating an example of a write command format according to one embodiment of the present invention.

FIG. 7 is a block diagram illustrating an example of a system having redundancy of update storing HDD devices according to one embodiment of the present invention.

FIG. 8 is a block diagram illustrating an example of a system in which a plurality of update storing HDD devices are used in response to the number of data storing HDD devices according to one embodiment of the present invention.

### DETAILED DESCRIPTION OF THE INVENTION

Embodiments of the present invention provide an external storage system which comprises a plurality of magnetic disk units including an external storage device or history storing device that stores, as a history, update information about the magnetic disk units such as HDD devices, and that can perform data recovery with a high degree of accuracy whenever a failure occurs.

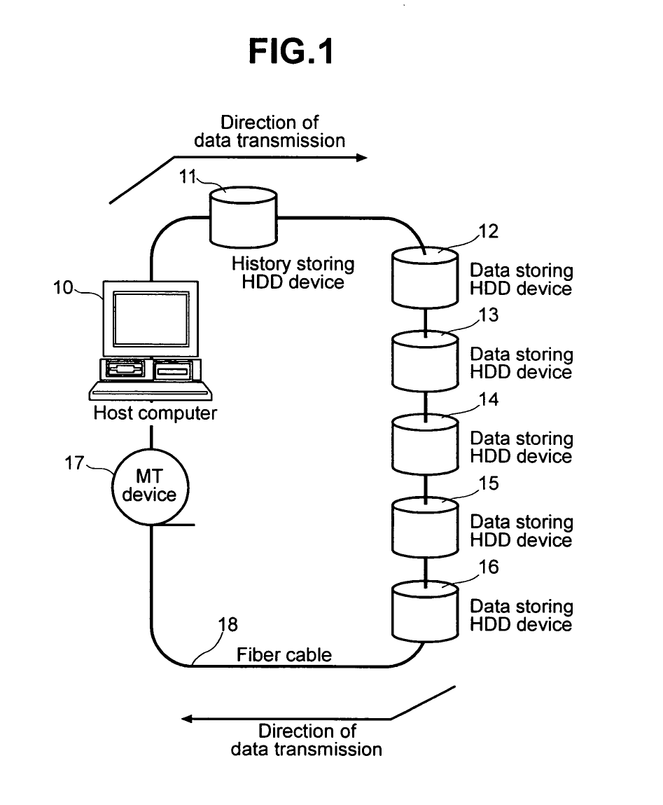

To begin with, a configuration example of an external storage system which includes a history storing device for storing update history according to one embodiment of the present invention will be described with reference to FIG. 1. FIG. 1 is a configuration diagram illustrating the system including the history storing device for storing update history information. The system including the history storing device according to this embodiment is a system that uses a HDD device as an example of a magnetic disk unit. In the specific embodiment, the system comprises a host computer 10; a history storing HDD device 11 placed at a downstream point directly connected to this host computer 10; usual data storing HDD devices 12 through 16; and an MT (magnetic tape) device 17 for performing periodic backup. The history storing HDD device 11 and the data storing HDD devices 12 through 16 are provided to constitute the external storage system of the host computer 10.

In this system, the host computer 10, all of the HDD devices (the history storing HDD device 11 and the data storing HDD devices 12 through 16), and the MT device 17 are connected to one another via a fiber cable 18, which forms a loop based on the FCAL protocol. In addition, a direction of data transmission is as follows: the host computer 10→the history storing HDD device 11→the data storing HDD device 12→ . . . →the data storing HDD device 16→the MT device 17. Each of them is kept in a through state when data is not required to be stored in its own storage medium.

The history storing HDD device 11 is used exclusively for storing update histories of the data storing HDD devices 12 through 16, and accordingly does not accept a usual write command. However, a command can be used to switch the use of the history storing HDD device 11, so that the device can be used for storing update histories in an update history storing mode, or for storing usual data in a usual data storing mode. If the history storing HDD device 11 is used for storing update histories, the update history storing mode is enabled.

This history storing HDD device 11 has a function of monitoring all frames issued from the host computer 10 to all of the data storing HDD devices 12 through 16 in the update history storing mode. Because all command frames issued from the host computer 10 always pass through the history storing HDD device 11, it is possible to monitor the frames. Moreover, the history storing HDD device 11 also has a function whereby when monitoring the frames, if a write command frame or a write data frame is found, its command/data information is automatically obtained to store the information in its own HDD medium.

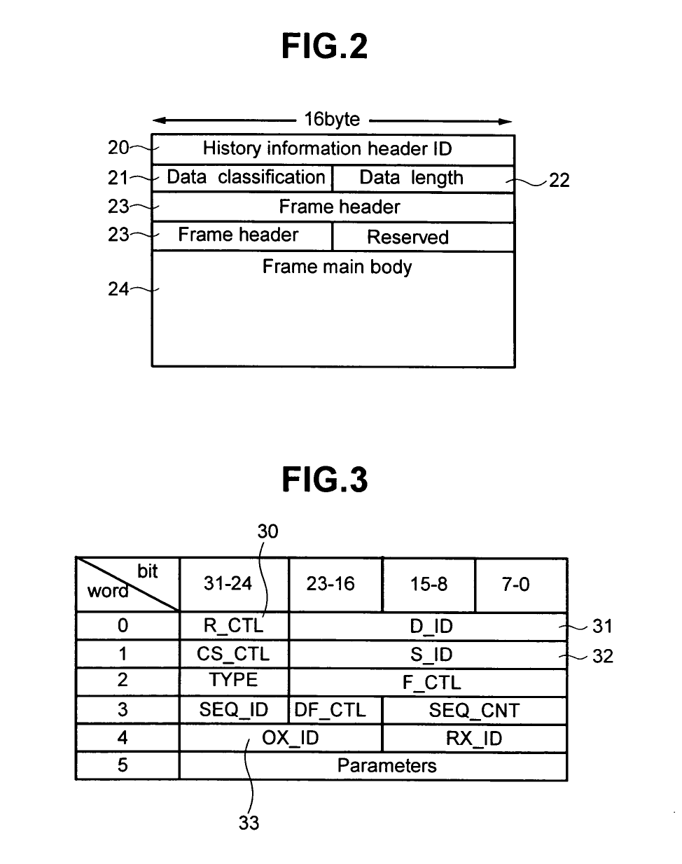

Next, a format example of update history information will be described with reference to FIG. 2. FIG. 2 is an explanatory diagram illustrating a format of update history information. A format of the update history information has fields including history information header ID 20, data classification 21, data length 22, frame header 23, reserved, and frame main body 24. If the history storing HDD device 11 finds a write command frame in the update history storing mode, the history storing HDD device 11 stores in its own HDD the update history information in this format.

The history information header ID 20 is an ID indicating the top of history information data. A character string ‘BACKUPHEADERID’ is filled in this field (the last 2 characters are blank). The history information header ID 20 is used for data retrieval when restoring data from the history information.

The data classification 21 indicates the classification of this information. In the case of the write command, a character string ‘COMMAND’ is filled in this field. In the case of written data, a character string ‘DATA’ is filled in this field.

The data length 22 indicates the number of bytes of the frame main body 24. In the case of the write command, the number of bytes of the frame main body 24 is 32. Accordingly, 20h is stored in the data length 22.

In the field of the frame header 23, a frame header prescribed by the FCAL protocol is stored. The frame according to the FCAL protocol has the frame header 23 and the frame main body 24. The frame header 23 stores contents of the subsequent frame, a source ID, a destination ID, a sequence ID used when the frame is divided into a plurality of frames, and the like.

The frame main body 24 stores a frame main body transmitted subsequent to the frame header 23. In the case of the write command, a frame in the format prescribed by the FCAL protocol is stored in this area. On the other hand, in the case of the written data, a data string itself is stored in this area.

Next, a format example of the frame header according to the FCAL protocol will be described with reference to FIG. 3. FIG. 3 is an explanatory diagram illustrating a format of the frame header according to the FICAL protocol.

In the frame header format according to the FCAL protocol, bits 31 through 24 of a word 0 are assigned as a field of R_CTL 30, and bits 23 through 0 of the word 0 are assigned as a field of D_ID 31. In a similar manner, the following fields are provided: bits 31 through 24 of a word 1 are assigned as CS_CTL, and bits 23 through 0 of the word 1 are assigned as S_ID 32; bits 31 through 24 of a word 2 are assigned as TYPE, and bits 23 through 0 of the word 2 are assigned as F_CTL; bits 31 through 24 of a word 3 are assigned as SEQ_ID, bits 23 through 16 of the word 3 are assigned as DF_CTL, and bits 15 through 0 of the word 3 are assigned as SEQ_CNT; bits 31 through 16 of a word 4 are assigned as OX_ID 33, and bits 15 through 0 of the word 4 are assigned as RX_ID; and bits 31 through 0 of a word 5 are assigned as Parameters. Detailed description of parameters which are not used in this embodiment will be omitted here.

The field of R_CTL 30 indicates the classification of a frame. In the case of the write command, 0Ch is stored in this field. In the case of written data, 01h is stored in the field.

The D_ID 31 is an ID that indicates a destination of the frame. This ID is an ID that can uniquely identify any device forming a loop. This information identifies one of the data storing HDD devices 12 through 16, to which a command or data relating to the stored history information has been transmitted.

The S_ID 32 is an ID that indicates a source of the frame. According to the present invention, writing operation from the host computer 10 to the data storing HDD devices 12 through 16 is monitored and stored. Accordingly, as for the S_ID 32, only the host computer 10 is a target to be monitored.

The OX_ID 33 is an ID used to specify that the frame is a series of command sequences. In the case of the write command, a command frame and subsequent one or more data frames are transmitted. In this case, the same OX_ID 33 is stored in the command frame and all subsequent data frames. Until a command sequence using a certain OX_ID 33 ends, the other command sequences cannot use the OX_ID 33.

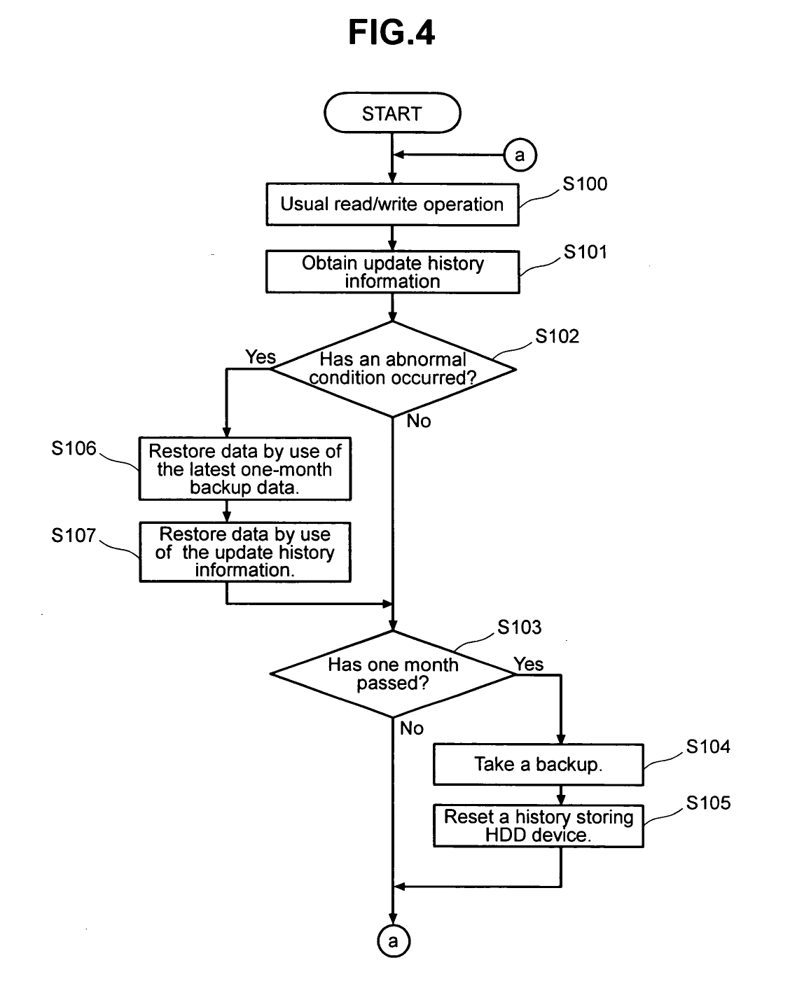

Next, a flow example of usual operation by an external storage system comprising an history storing device for storing update history according to this embodiment will be described with reference to FIG. 4. FIG. 4 is a flowchart illustrating the usual operation.

A step S100 is the usual read/write operation where writing of data from the host computer 10 to the data storing HDD devices 12 through 16, and reading of data from the data storing HDD devices 12 through 16 to the host computer 10, are performed.

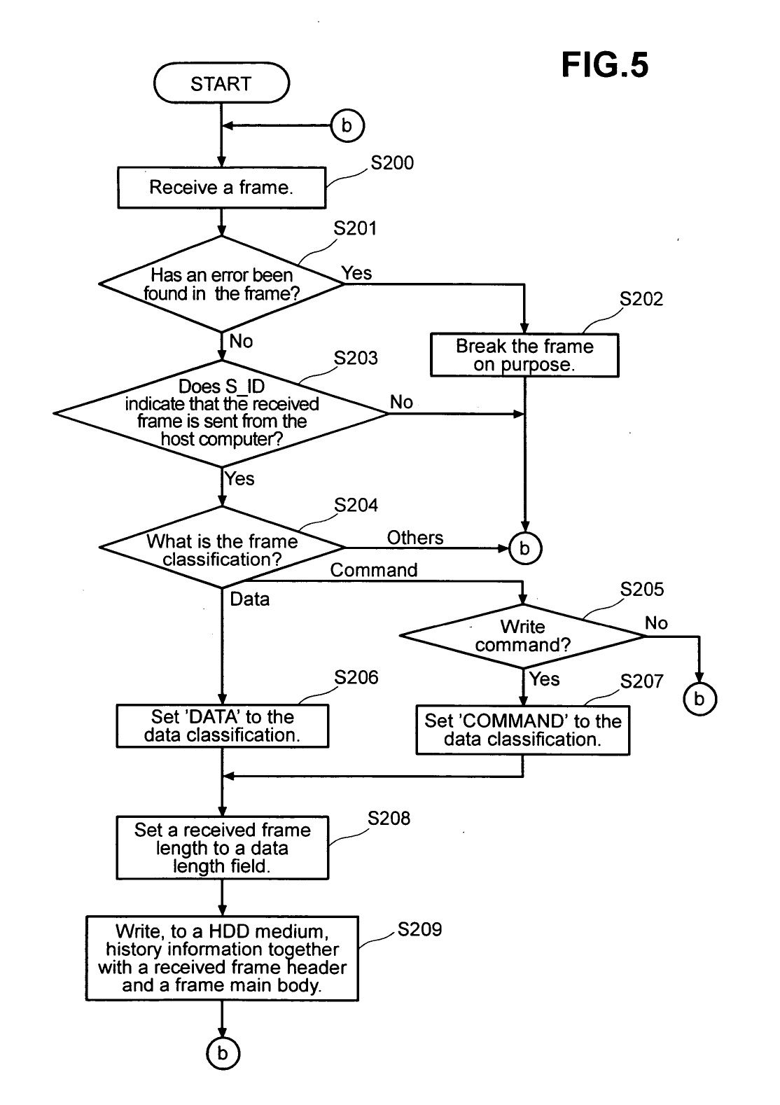

In a step S101, if data writing is performed in the step S100, the history storing HDD device 11 automatically obtains update history information about a write command and written data, and then stores the update history information in its own HDD medium, in the update history storing mode. This processing will be described later in detail in FIG. 5.

In a condition judgment step S102, a judgment is made as to whether or not an abnormal condition has occurred in the system. If no abnormal condition has occurred (No), a judgment is made in a next condition judgment step S103 as to whether or not, for example, one month has passed since the date of the last backup. Here, one month is used as an interval at which a periodic backup is performed. If it is judged that one month has not yet passed (No), the process returns to the processing from the step S100.

If it is judged that one month has already passed (Yes), data stored in the data storing HDD devices 12 through 16 is backed up in a step S104. To be more specific, the data is stored in the MT device 17 every month as periodic backup data.

Once the periodic backup data is stored, the update history information up to this point becomes unnecessary. Therefore, in a step S105, the HDD medium of the history storing HDD device 11 is reset. After that, the process returns to the processing from the step S100.

If it is judged in the condition judgment step 102 that an abnormal condition occurs in the system (Yes), in a step S106, data of all HDD media in the data storing HDD devices 12 through 16 is restored to a state of one month ago in a data restoration mode by use of the latest one-month backup data which has been periodically backed up to the MT device 17.

Then, by use of the update history information in the history storing HDD device 11, write commands, which have been issued by the host computer 10 during the last one month before the failure, are reissued to rewrite data which have been written during the last one month before the failure so that data of all HDD media in the data storing HDD devices 12 through 16 is restored. As a result, it is possible to restore the data of the HDD media in the data storing HDD devices 12 through 16 to a state immediately before the failure.

Next, an example of a flow used when the history storing HDD device obtains update history information will be described with reference to FIG. 5. FIG. 5 is a flowchart illustrating a case where the history storing HDD device obtains the update history information.

In a step S200, some frames are received. On the receipt of all of the frames, the history storing HDD device 11 performs the following processing before transmitting the data to the downstream data storing HDD devices 12 through 16.

In a condition judgment step S201, an error of a frame is analyzed. If an error is found (Yes), the process proceeds to processing of a step S202 where the frame is broken on purpose. For example, there is a method of breaking a frame by writing 111 . . . , 000 . . . , or the like, to a CRC part. The purpose of the above is to prevent the following problem: when the history storing HDD device 11 detects an error, if the data storing HDD devices 12 through 16 which are actual destinations of the frame do not detect the error, writing is performed without storing its history, resulting in improper history information stored, which makes it impossible to accurately recover data when a failure occurs.

If some frames are received in the step S200, a judgment is made in a condition judgment step S203 as to whether or not the received frames are sent from the host computer 10. If it is judged that the received frames are sent from other than the host computer 10 (No), the frames do not relate to writing by the host computer 10 to the data storing HDD devices 12 through 16. Accordingly, the frames are transmitted to the downstream direction just as they are, and then the process returns to a frame waiting state.

If it is judged that the frames are sent from the host computer 10 (Yes), the classification of the frames is judged in a next condition judgment step S204. The classification is judged by referring to the R_CTL 30 of the frame header 23. If the frame is a command, 0Ch is stored in the field of the R_CTL 30. On the other hand, if the frame is data, 01h is stored in this field.

If the R_CTL 30 is 01h and consequently it is judged that the frame is data, the process proceeds to a step S206 where ‘DATA’ is set to the data classification 21 before proceeding to a step S208.

If the R_CTL 30 is 0Ch and consequently it is judged that the frame is a command, the process proceeds to a step S205 for judging the command classification. The command classification is judged by referring to the frame main body 24. If it is judged that the frame is a write command (Yes), the process proceeds to a step S207 where ‘COMMAND’ is set to the data classification 21 before proceeding to a step S208. If it is judged that the frame is a command other than the write command (No), the process returns to a frame waiting state.

If the R_CTL 30 is neither 01h nor 0Ch, it is judged that the frames do not relate to writing. Accordingly, the frames are transmitted to the downstream direction just as they are, and the process then returns to a frame waiting state.

If the process proceeds to the processing step S208, a frame length of the received frame main body 24 is stored in the field of the data length 22. After that, the process proceeds to a processing step S209 where the received frame header 23 and the received frame main body 24 are arranged in the format shown in FIG. 2 and are then written to its own HDD medium. A location at which the writing is performed is a location that follows the location at which the last history has been written. In this case, in order to speed up the writing of the history, processing such as sort is not performed.

In this manner, history information about all write commands issued from the host computer 10 to the data storing HDD devices 12 through 16 is created in the history storing HDD device 11. Whenever any of the data storing HDD devices 12 through 16 gets out of order, it is possible to restore data from the history information.

Subsequently, data restoring method used in a case where a failure occurs will be described in detail. This data restoring method is performed in the data restoration mode of the system.

Because what is obtained in the steps shown in FIG. 5 is detailed writing history information, it is necessary to get back to a state at a certain point of time in the past, and then to restore the data. In order to get back to a state at a certain point of time in the past, the backup which has been periodically obtained by the conventional method is used as described in the step S104 in FIG. 4. However, storing all history information from the time when the use of the drive is started eliminates the need for using the backup. However, it takes much time for the recovery, and the amount of the history information enormously increases. Therefore, as described above, periodically conducting a backup, for example, every month, or the like, is more practical.

After getting back to the state at a certain point in time in the past, by use of a dedicated history reproduction tool, while reading the history information, writing by the host computer 10 to the data storing HDD devices 12 through 16 is reproduced completely in the same manner as what has been performed in the past. This history reproduction tool reproduces a history in the following steps.

The history information header ID 20 is found in the history information. If the history information is correctly created, the top of the history information is the history information header ID 20. If the history information header ID 20 is found, processing to be performed is determined by referring to the data classification 21. If the history information is correctly created, the data classification 21, which is data on the top, is ‘COMMAND’.

If history information of the write command is found, history information of data that follows the write command is searched for. The OX_ID 33 is used for the search. A set of a write command and its data string use the same OX_ID, and this OX_ID is a unique value until the write command is completed. Therefore, if history information having the same OX_ID 33 is searched for, all write data can be found.

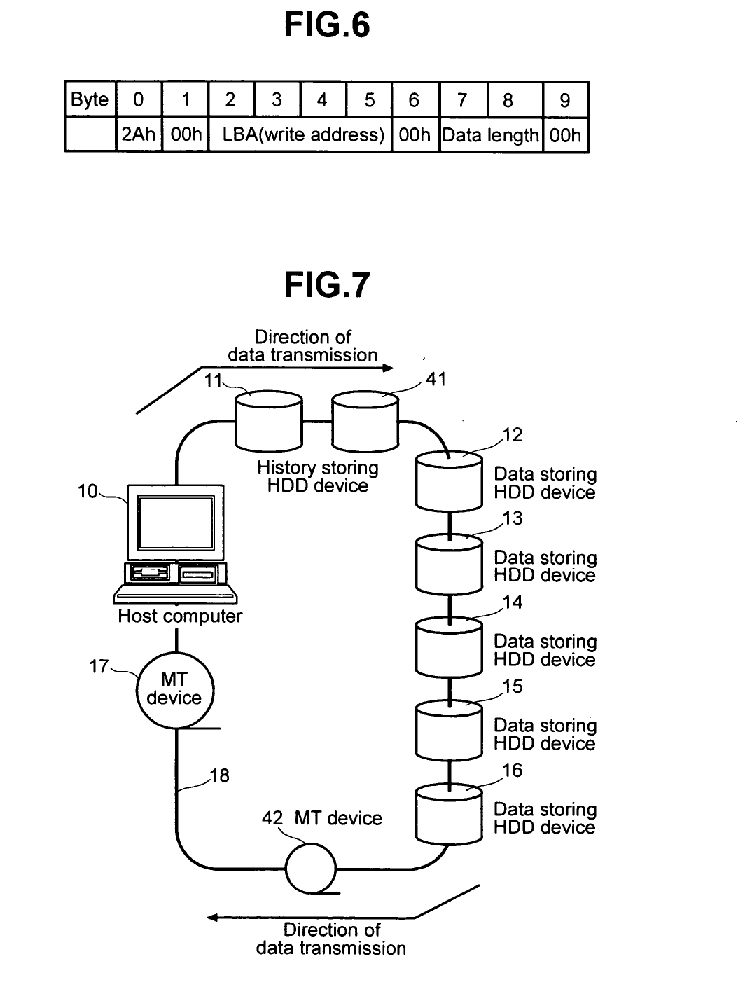

The end of data is judged by a data length of CDB stored in the frame main body 24 of the write command. The CDB is a data string indicating command contents prescribed by SCSI. In the case of a write command, the CDB is expressed in the format shown in FIG. 6. The data length is stored in bytes 7 and 8.

As soon as both the write command and its data are found, a write command which is the same as that issued before is issued to the data storing HDD device 12 (13 through 16) as a target on the basis of the information about the write command and its data. The target data storing HDD device 12 (13 through 16) can be identified by the D_ID 31. As CDB of the command, the same CDB as that stored in the history information is used.

As soon as the reproduction of one write command is completed, a search of the next command, a search of its data, and an issuance of a write command are repeated. If the reproduction of all write commands in the history information is finished, this means that all data of the HDD media in the data storing HDD devices 12 through 16 are reproduced.

In addition, when preparing for an emergency, data in the history storing HDD device 11 can also be migrated to a low-speed, high-capacity storage medium on a periodic basis such as, for example, once a day. In this case, as described later in FIG. 7, even when the data is being migrated, the system can be continuously used by connecting a spare history storing HDD device instead.

Next, a configuration example of a system having redundancy of update storing HDD devices will be described with reference to FIG. 7. FIG. 7 is a block diagram illustrating a system that uses two update storing HDD devices.

In the system having redundancy of the update storing HDD devices, a plurality of history storing HDD devices 11, 41 (two devices in the figure) are connected to the loop through the fiber cable 18. History information is stored in one operating history storing HDD device, whereas the other history storing HDD device which is not operating is in a through state. Moreover, a MT device 42 to which data of HDD media in the history storing HDD devices 11, 41 are migrated is also connected to the loop through the fiber cable 18.

For example, even if one history storing HDD device 11 is stopped for the purpose of migrating data of a HDD medium in this history storing HDD device 11 to the MT device 42, operating the other history storing HDD device 41 permits update histories to be continuously obtained while allowing the system to operate.

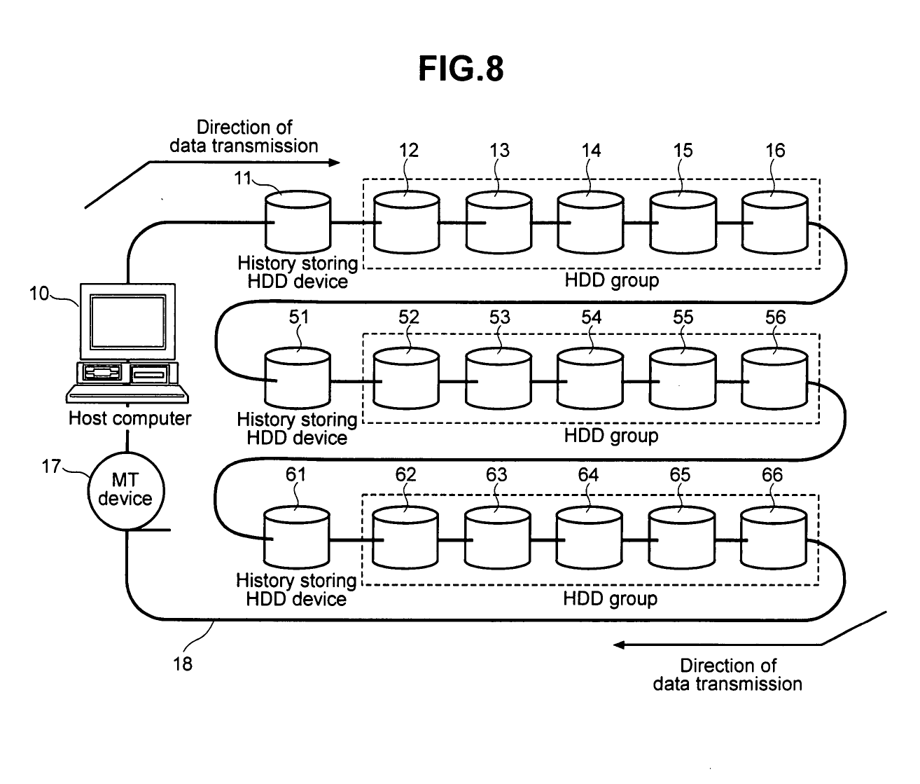

In addition, if many data storing HDD devices are used in one system, there is a possibility that the update storing HDD device will fall short of the capacity. In this case, as described later in FIG. 8, it is possible to solve the problem by increasing the number of update storing HDD devices in response to the number of data storing HDD devices.

Next, a configuration example of a system in which a plurality of history storing HDD devices are used in response to the number of data storing HDD devices will be described with reference to FIG. 8. FIG. 8 is a block diagram illustrating a system in which three history storing HDD devices are used corresponding to fifteen data storing HDD devices.

In this system, the fifteen data storing HDD devices are divided into three HDD groups, each HDD group being constituted of five data storing HDD devices: to be more specific, data storing HDD devices 12 through 16, data storing HDD devices 52 through 56, and data storing HDD devices 62 through 66. Corresponding to those three HDD groups, history storing HDD devices 11, 51, 61 for storing update histories are provided at upstream points directly connected to the corresponding HDD groups respectively.

The history storing HDD device 11 obtains update histories of all data storing HDD devices 12 through 16 belonging to the first HDD group. In a similar manner, the history storing HDD device 51 obtains update histories of the second HDD group; and the history storing HDD device 61 obtains update histories of the third HDD group. As a result, as for the shortage of the capacity of the history storing HDD device caused by many data storing HDD devices used, it is possible to cope with such a problem by increasing the number of history storing HDD devices.

Thus, according to this embodiment, it is possible to obtain detailed update histories during the operation of the system by: using data transmission by a bucket brigade method according to the FCAL protocol; placing at a downstream point directly connected to the host computer 10 the history storing HDD device 11 that is specifically used for storing an update history of data; monitoring by this history storing HDD device 11 all write commands and their accompanying data which have been transmitted to the downstream data storing HDD devices 12 through 16; and automatically storing by the history storing HDD device 11 all the write commands and the accompanying data in its own HDD medium without the intervention of the host computer 10. Accordingly, whenever a failure occurs in the system, it is possible to accurately restore the data to a state immediately before the occurrence of the failure.

In addition, if the plurality of history storing HDD devices 11, 41 are used, even if one of them is stopped, it is possible to continuously obtain update histories by use of the other history storing HDD device while allowing the system to operate.

Moreover, if the plurality of data storing HDD devices 12 through 16, 52 through 56, and 62 through 66 are used, by using the plurality of history storing HDD devices 11, 51, 61 corresponding to them, it possible to obtain update histories of many data storing HDD devices.

Further, if the history storing HDD device 11 (41, 51, 61) finds an error of a frame, breaking the frame on purpose makes it possible to accurately recover data without making a mistake in the event of the occurrence of a failure.

In this embodiment, a system that uses the HDD device as an example of a magnetic disk unit has been described. However, a magnetic disk unit used is not limited to a HDD device. The present embodiment can be broadly applied to a system comprising a magnetic disk unit in which a different kind of magnetic disk is used as a storage medium.

According to the present invention, by automatically obtaining and storing detailed update histories from the last backup during the operation of a system without the intervention of a host computer, whenever a failure occurs in the system, it is possible to accurately restore data to a state immediately before the occurrence of the failure. Accordingly, it becomes possible to perform data recovery with a high degree of accuracy.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims along with their full scope of equivalents.

1. An external storage system comprising:
a plurality of magnetic disk units being connected to one another according to a fiber channel protocol,
wherein at least one of the plurality of magnetic disk units is a history storing device that monitors each frame being transmitted to the plurality of magnetic disk units, and has an update history storing mode in which update history information is automatically obtained and stored in a storage medium of the history storing device.

2. An external storage system according to claim 1,
further comprising a host computer connected with the plurality of magnetic disk units according to the fiber channel protocol; and
wherein the history storing device having the update history storing mode is placed at a downstream location adjacent to the host computer in a frame transmission direction for frames being transmitted to the plurality of magnetic disk units.

3. An external storage system according to claim 1,
further comprising a host computer connected with the plurality of magnetic disk units according to the fiber channel protocol; and
wherein the plurality of magnetic disk units comprise a plurality of history storing devices that monitor frames being transmitted to the plurality of magnetic disk units and each have an update history storing mode in which update history information is automatically obtained and stored in a storage medium thereof.

4. An external storage system according to claim 3, wherein the plurality of history storing devices having the update history storing mode are configured such that even if one of the history storing devices having the update history storing mode is stopped, remaining history storing devices having the update history storing mode continuously obtain the update history information while allowing the external storage system to operate.

5. An external storage system according to claim 1,
further comprising a host computer;
wherein the plurality of magnetic disk units are divided into a plurality of groups, and are connected to the host computer according to the fiber channel protocol; and
wherein the plurality of magnetic disk units comprise a plurality of history storing devices that monitor frames being transmitted to the plurality of magnetic disk units and each have an update history storing mode in which update history information is automatically obtained and stored in a storage medium thereof, each of the plurality of external storage units having an update history storing mode corresponding to one of the plurality of groups, and each of the plurality of history storing devices having the update history storing mode is placed at an upstream location adjacent to the one of the plurality of groups in a frame transmission direction for frames being transmitted to the plurality of magnetic disk units.

6. An external storage system according to claim 1, wherein the history storing device having the update history storing mode is configured to perform a function whereby a frame received from a host computer is analyzed, and then if an error is found in the frame, a part of the frame is broken.

7. An external storage system according to claim 1,
further comprising a host computer connected with the plurality of magnetic disk units according to the fiber channel protocol; and
wherein the history storing device having the update history storing mode includes a data restoration mode in which if a failure occurs in the external storage system, by use of the update history information stored in the history storing device having the update history storing mode, write commands issued by the host computer before the occurrence of the failure are reissued to rewrite data that has been written before the failure, so as to restore data of the plurality of magnetic disk units.

8. An external storage system according to claim 7, wherein the history storing device having the data restoration mode is configured to perform a function whereby before restoring data by use of the update history information stored in the history storing device, data of the plurality of magnetic disk units is restored by use of backup data which has been periodically taken from the plurality of magnetic disk units.

9. An external storage system according to claim 1, wherein the plurality of magnetic disk units are connected to one another by a fiber channel arbitrated loop.

10. An external storage system comprising:
a plurality of magnetic disk units which are connected according to a fiber channel protocol,
wherein at least one of the plurality of magnetic disk units is a history storing device which is configured to monitor frames being transmitted to the plurality of magnetic disk units in a frame transmission direction, and to operate in an update history storing mode by obtaining and storing update history information of the plurality of magnetic disk units in a storage medium of the history storing device.

11. An external storage system according to claim 10, further comprising a host device connected with the plurality of magnetic disk units according to the fiber channel protocol, the host device being configured to transmit the frames to the plurality of magnetic disk units; wherein the history storing device is configured to obtain and store update history information of the plurality of magnetic disk units in the update history storing mode without intervention from the host device.

12. An external storage system according to claim 11, wherein the history storing device is placed at a downstream location adjacent to the host device in the frame transmission direction.

13. An external storage system according to claim 11, wherein the plurality of magnetic disk units comprise a plurality of history storing devices that are configured to monitor the frames being transmitted to the plurality of magnetic disk units in the frame transmission direction, and to operate in an update history storing mode by obtaining and storing update history information of the plurality of magnetic disk units in storage media of the history storing devices.

14. An external storage system according to claim 13,
wherein the plurality of magnetic disk units are divided into a plurality of groups connected in series with the host device according to the fiber channel protocol,
wherein each group includes a history storing device configured to monitor frames being transmitted to the plurality of magnetic disk units of the group, and to operate in an update history storing mode by obtaining and storing update history information of the plurality of magnetic disk units of the group in a storage medium of the history storing device.

15. An external storage system according to claim 11, wherein the history storing device is configured to operate in a data restoration mode in which if a failure occurs in the external storage system, by use of the update history information stored in the history storing device, write commands issued by the host computer before the occurrence of the failure are reissued to rewrite data that has been written before the failure, so as to restore data of the plurality of magnetic disk units.

16. An external storage system according to claim 15, wherein the history storing device is configured to perform a function whereby before restoring data by use of the update history information stored in the history storing device, data of the plurality of magnetic disk units is restored by use of backup data which has been periodically taken from the plurality of magnetic disk units.

17. A method of storing information relating to a plurality of magnetic disk units connected to one another according to a fiber channel protocol in an external storage system, wherein at least one of the plurality of magnetic disk units is a history storing device, the method comprising:
monitoring, by the history storing device, frames being transmitted to the plurality of magnetic disk units in a frame transmission direction; and
obtaining and storing update history information of the plurality of magnetic disk units in a storage medium of the history storing device operating in an update history storing mode.

18. A method according to claim 17, further comprising:
transmitting the frames from a host device connected to the plurality of magnetic disk units according to the fiber channel protocol, wherein the plurality of magnetic disk units are divided into a plurality of groups connected in series with the host device according to the fiber channel protocol, wherein each group includes a history storing device; and
monitoring frames being transmitted to the plurality of magnetic disk units of each group by the history storing device in the group, and operating the history storing device in an update history storing mode by obtaining and storing update history information of the plurality of magnetic disk units of the group in a storage medium of the history storing device.

19. A method according to claim 17, further comprising:
operating the history storing device in a data restoration mode in which if a failure occurs in the external storage system, by use of the update history information stored in the history storing device, write commands issued by the host computer before the occurrence of the failure are reissued to rewrite data that has been written before the failure, so as to restore data of the plurality of magnetic disk units.

20. A method according to claim 19, further comprising:
performing an operation by the history storing device whereby before restoring data by use of the update history information stored in the history storing device, data of the plurality of magnetic disk units is restored by use of backup data which has been periodically taken from the plurality of magnetic disk units.
